(19) United States
(12) Patent Application Publication
(10) Pub. No.: US 2011/0315326 A1
(43) Pub. Date: Dec. 29, 2011

(54) Tire Bead Lifting Tool

(76) Inventors: Daniel H. Jouve, Davie, FL (US); Dale L. Dienst, Wesley Chapel, FL (US)

(21) Appl. No.: 13/166,062

(22) Filed: Jun. 22, 2011

Related U.S. Application Data
(60) Provisional application No. 61/358,047, filed on Jun. 24, 2010.

(51) Int. Cl. B60C 25/02

(52) U.S. Cl. 157/1.3

(57) ABSTRACT

A tool for lifting tire beading is disclosed. The invention is of unitary construction and includes a generally straight central section with an I-beam shaped cross-section, and a first end with a cylindrical handle disposed thereon. At the other end is an engaging end that comprises a curved hook for being inserted between the tire bead and the rim of the wheel. The handle portion is disposed at an angle such that when full leverage is applied to disengage the bead from the rim, the users hand does not come in contact with the tire itself.

### RELATED APPLICATIONS

This utility application claims priority from 61/358,047 filed by Daniel Jouve and Dale Dienst on Jun. 24, 2010.

### FIELD OF INVENTION

The invention relates to an apparatus which may be employed as a lever, and more specifically, to a tire bead lifting tool that permits the user of the apparatus to remove a tire from a wheel.

### BACKGROUND OF THE INVENTION

The removal of a tire from its associated tire wheel is generally performed when a consumer purchases new tires to replace worn tires. Alternatively, tires are removed from its associated wheel when a new wheel is replacing an old wheel. Also, a tire may be removed from a wheel in order to facilitate repairs on the tire or conversely, repairs to the wheel.

### SUMMARY OF THE INVENTION

A tire bead lifting tool is provided. It is approximately between 20 and 25 inches long. It includes a handle attached to and elongated lever which terminates in a prying element. The handle is angularly disposed in relation to the elongated lever. A range of angles between the handle and the elongated lever has been contemplated. In a preferred embodiment a 20 degree angle is selected. The handle is a generally cylindrical and solid. Located on the outside of the cylindrical handle are a plurality of bands of diamond patterned knurling. The elongated lever has a cross-section. The cross-section has the appearance of an I-beam. The prying element includes a rounded end at the terminus, and a curved hook portion. The rounded end enables the lever to penetrate the tire bead-wheel rim interface. The curved hook portion allows the tire to be pried away from the rim. The handle is oriented such that the users hand does not come into contact with any tire-wheel component. The tire bead lifting tool is then moved about the circular interface of the tire bead-wheel rim interface, freeing the wheel from the tire and permitting replacement or repair of the tire or wheel. The tire bead lifting tool is of unitary construction and is preferably made of steel.

These and other features and other advantages of the present invention will now be described in further detail with reference to the accompanying drawings wherein:

### BRIEF DESCRIPTION OF THE DRAWINGS

FIG. 1 is a bottom plan view of the tire bead lifting tool of the present invention.

FIG. 2 is a side view of the tire bead lifting tool of the present invention.

FIG. 3 is a top plan view of the present invention showing the prying end and the angled handle end.

FIG. 4 is an enlarged perspective view of a portion of the handle end showing the knurling to assist in the user gripping the device.

FIG. 5 is a cross sectional view of the invention taken at line B-B of FIG. 1.

FIG. 6 is a perspective view of the tire bead lifting tool of the present invention.

FIG. 7 is a view of the tire bead lifter of the present invention in use disengaging the bead from the tire (seen in cross-section).

FIG. 8 is a perspective view of the tire bead lifter of the present invention in use.

### DETAILED DESCRIPTION OF THE PREFERRED EMBODIMENT

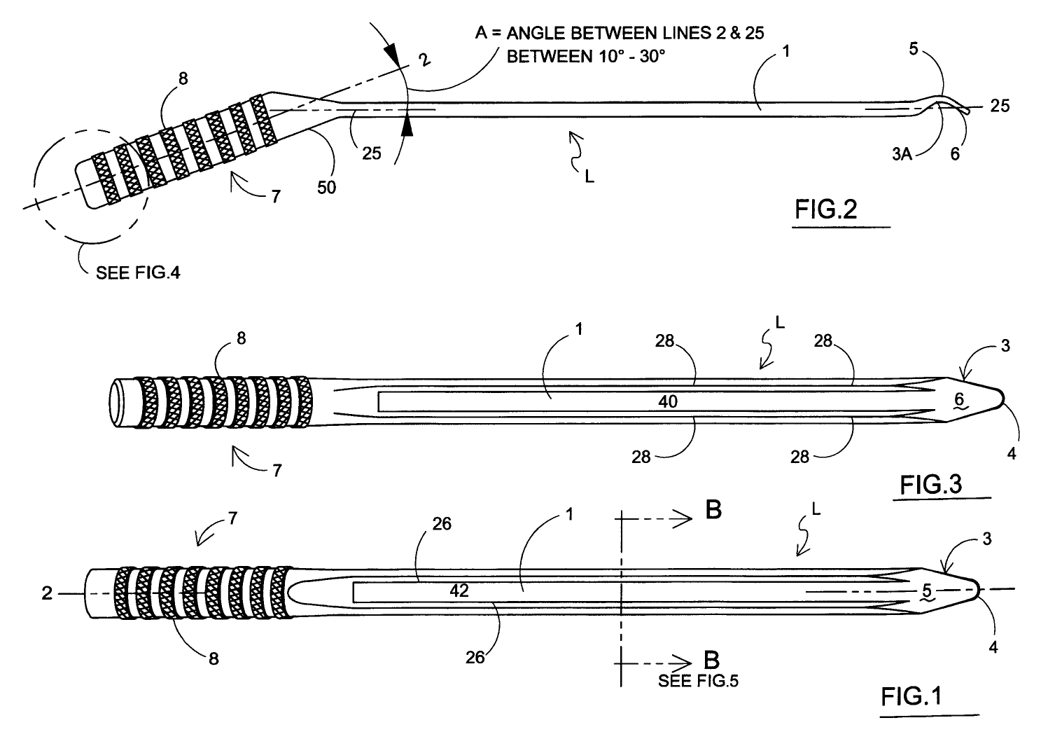

Referring first to FIGS. 1-3 the tire bead lifter L is shown. The tire bead lifter L may preferably be made from steel and further may include a chrome finish. Other materials may be employed, including but not limited to, iron, aluminum, composites, bronze, titanium, carbon fiber, laminates including fiber metal laminates, alloys of steel and treated steel such as quenched, tempered, stainless, cold rolled or annealed steel. Other materials of sufficient material properties, especially those that tend not to bend or non-deformable when employed as a lever may also be used.

The tire bead lifter L has a handle end 7 which is substantially cylindrical and has a surface area. The surface area includes knurling 8 to assist the user in gripping the handle 7. Knurling 8 could be formed of a raised metal surface, inset rubber, plastic, nylon, or any number of other materials known or unknown in the art that would aid the user 30 in maintaining a firm grasp on the handle end 7.

Handle end 7, as is seen in FIG. 2 is disposed at an angle relative to the longitudinal axis 2 (seen in FIG. 1) of the central body portion 1 in a range of between 10 to 30 degrees such that it conforms to the prying or bead engagement end 3.

The handle 7, central section 1 and bead engagement end 3 are unitary. The handle 7 is substantially cylindrical and at the end proximate to the central section 1, the cylindrical shape is drawn to a substantially flat shape. When viewed in cross-section the flat shape takes on the shape of an I-beam as seen in FIG. 5.

The central section 1 of the present invention as can be seen in FIGS. 1, 2, 3, and 5 is generally straight and has, as mentioned above, a longitudinal axis 2. Referring now to the cross-sectional view in FIG. 5, in the embodiment described herein, this cross-section has the general shape of an I-beam. Also seen in FIG. 5 are the central section vertical axis indicated at 20 and the horizontal axis at 22.

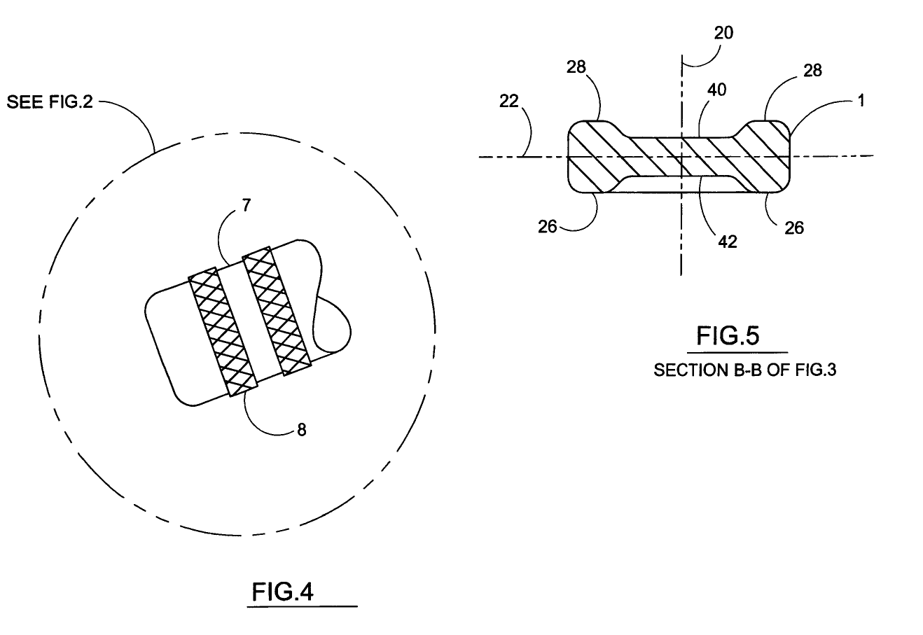

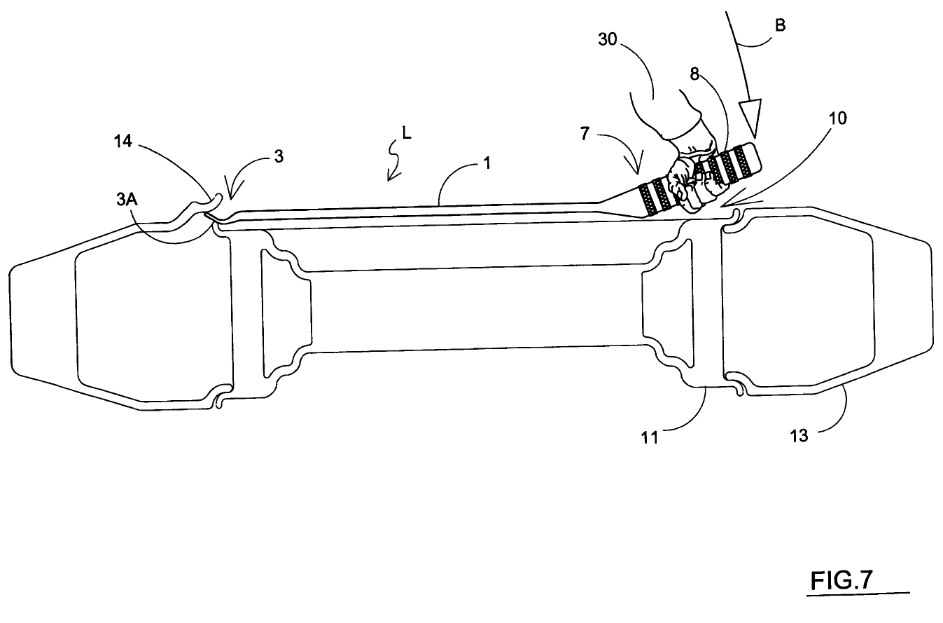

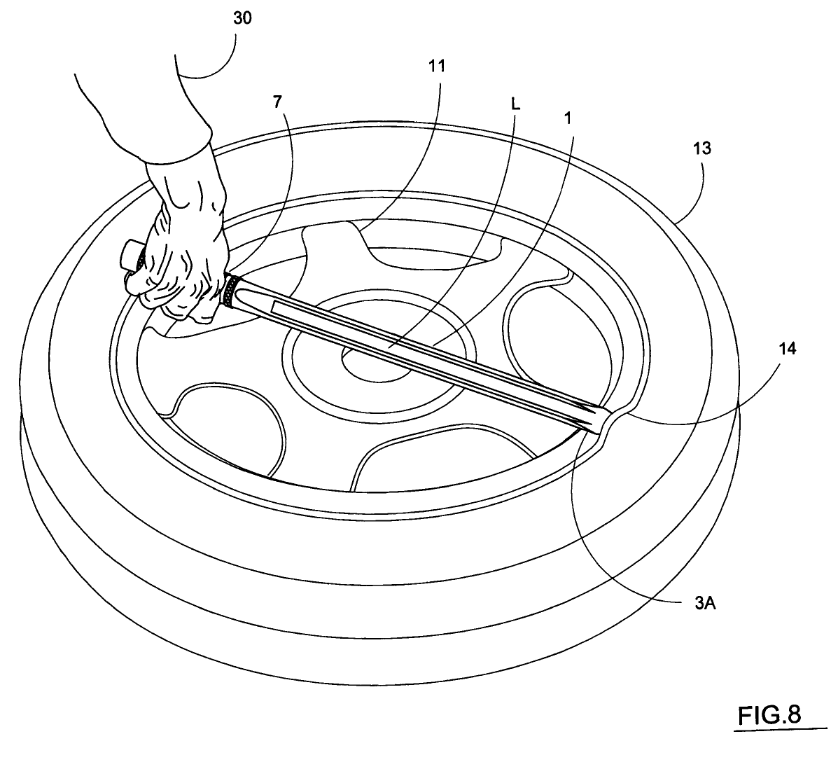

Turning again to FIGS. 1-3 the prying or bead engaging end 3 is shown. The engaging end 3 has a rounded distal tip 4 seen in FIGS. 1 and 3. Additionally as seen in FIG. 2 the engaging end 3 has a rounded outward convex portion 5 and an inwardly concave portion 6 that form a curved hook 3A. The curved hook 3A is designed to engage the bead 14 and urge it out of the slot holding it to the wheel as is shown in FIG. 7.

Turning specifically to FIG. 1, a bottom plan view of the tire bead lifting tool L is shown. A handle central axis 2 is provided for the tire bead lifting tool L. A generally cylindrical handle 7 is shown which includes knurling 8. The knurling 8 may be an intermittent raised surface to permit the user to grasp the handle 7 more firmly.

At this point the handle 7 tapers down to a central body portion 1. The central body portion 1 is generally flat in a first approximation, however in cross-section it has the appearance of an I-beam with the I laying down. The two downwardly facing outer portions of the I are shown as element 26. The central downward oriented portion of the I is shown as element 42. The central body portion 1 terminates on right side of FIG. 2 at a rounded distal tip 4. The rounded distal tip, along with the rounded outward convex portion 5, forms the lower portion of the bead engaging end 3.

Turning now specifically to FIG. 3, a top plan view of the tire bead lifting tool L of the present invention is shown. The handle 7 and knurling 8 are essentially the same as that shown in FIG. 1. The central body portion 1 is once again generally flat in a first approximation, however in cross-section it has the appearance of an I-beam with the I laying down. The two upwardly facing outer portions of the I are shown as element 28. The central upward oriented portion of the I is shown as element 40. The central body portion 1 terminates on right side of FIG. 2 at a rounded distal tip 4. The rounded distal tip 4, along with the rounded outward concave portion 6, forms the upper portion of the bead engaging end 3.

Turning now specifically to FIG. 2, a side view of the tire bead lifting tool L is provided , showing the prying end and the angled handle end. The handle 7 and the knurling 8 are essentially the same as that shown in FIGS. 1 and 3. The handle 7 tapers 50 down to the central body portion 1. An angle is formed between the handle 7 and the central body portion 1. Line 2 shown bisecting the handle is the handle central axis 2 of FIG. 1. Line 25 is shown bisecting the central body portion 1. The angle A formed betwixt line 2 (handle central axis) and line 25 (central axis of central body portion 1) may be in the range of 10 to 30 degrees. An angle of 20 degrees may be chosen in one embodiment of the invention.

The bead engaging end 3 is located on the right side of FIG. 2. The rounded outward concave portion 6 and the rounded outward convex portion 5 form a curved hook 3A. The curved hook 3A is designed to engage the bead 14 and urge it out of the slot holding it to the wheel as is shown in FIG. 7.

Referring now to FIG. 4, an enlarged perspective view of a portion of the handle 7 including the knurling 8 is shown. The view is taken from the circle of dashed lines shown about the handle 7 in FIG. 2. The knurling 8 may be an intermittent raised surface to permit the user to grasp the handle 7 more firmly. Knurling 8 could be formed of a raised metal surface, inset rubber, plastic, nylon, or any number of other materials known or unknown in the art that would aid the user 30 (See FIG. 7) in maintaining a firm grasp on the handle 7.

FIG. 5 is a cross-section of the central body portion 1 taken along line B-B of FIG. 1. As taught above, the cross-section appears as an I beam laying on its side. A central section vertical axis 20 and the central section horizontal axis 22 are shown. The two upwardly facing outer portions of the I are shown as element 28. The central upward oriented portion of the I is shown as element 40. The two downwardly facing outer portions of the I are shown as element 26. The central downward oriented portion of the I is shown as element 42.

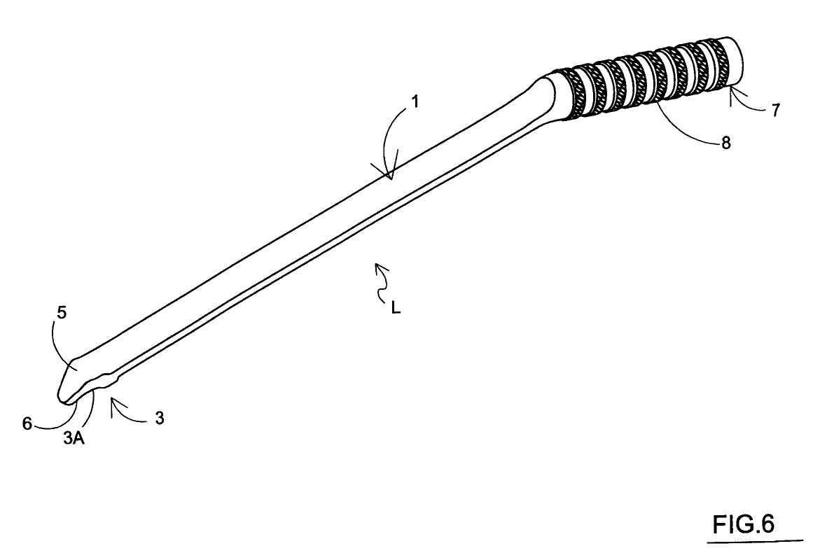

Referring now specifically to FIG. 6, a perspective view of the tire bead lifting tool L is shown. Handle 7 with knurling 8 is shown disposed at an angle to central body potion 1. The bead engaging end 3 is located on the left side of FIG. 6. The rounded outward concave portion 6 and the rounded outward convex portion 5 form a curved hook 3A. The curved hook 3A is designed to engage the bead 14 and urge it out of the slot holding it to the wheel as is shown in FIG. 7.

Referring now specifically to FIG. 7, a view of the tire bead lifter L in use disengaging the bead from the tire and rim (seen in cross-section). FIG. 7 is directed to the operation of the tire bead lifter L. As mentioned above, the handle end 7 is disposed at an angle of 10 to 30 degrees in relation to the central section longitudinal axis 2. A preferred angle is approximately 20 degrees has been previously discussed. This angled handle 7 permits the users 30 hand to be able to grasp the handle 7 without the wheel 11 or tire 13 coming into contact with said hand when the tire bead lifter L is in its maximum leverage. Bead engagement end 3 using the rounded distal tip 4 is fitted between the tire bead 14 and wheel 11 and may be worked to break the seal between the tire 13 and wheel 11 as seen in FIG. 7. The tire bead lifter L by means of handle end 7 is moved in the direction indicated by arrow b and thus by working the engagement end 3 about the periphery of one side of the tire and wheel the tire 13 may be disengaged from the wheel 11 for either replacement or repair of either.

Referring now to FIG. 8, the handle 7 of the tire bead lifter L is being grasped by user 30. The central body portion 1 acts as a lever for hook 3A which is shown breaking the seal between the wheel 11 and the tire 14. Hook 3A is shown at about the 4:00 o'clock position in FIG. 8. The tire bead lifter L is designed to move back to the 4:00 o'clock position by moving about the tire 14/wheel 11 interface in either a clockwise or counterclockwise fashion. After moving through the 360 degrees, the tire 11 will be separated from the wheel 11.

I claim:

1. A tire bead lifting tool including:
a handle,
a central section, said central section having a proximal end, and a distal end,
a tire bead engaging means,
said handle, said central section, and said tire bead engaging means being of unitary construction,
wherein said handle is angularly offset to said central section proximal end by a first angle, and said
central section distal end terminating at said tire bead engaging means.

2. A tire bead lifting tool as claimed in claim 1 wherein said handle is generally cylindrical and includes an outside surface area, said surface area including grip enhancement means.

3. A tire bead lifting tool as claimed in claim 2 wherein said generally cylindrical handle tapers to a generally flat central section.

4. A tire bead lifting tool as claimed in claim 3 wherein said generally flat central section includes a cross -section wherein said cross-section is in the shape of an I-beam.

5. A tire bead lifting tool as claimed in claim 1 wherein said first angle is chosen to be in the range between 10 to 30 degrees.

6. A tire bead lifting tool as claimed in claim 1 wherein said first angle is chosen to be 20 degrees.

7. A tire bead lifting tool as claimed in claim 1 wherein said tire bead engaging means includes a rounded tip.

8. A tire bead lifting tool as claimed in claim 7 wherein said tire bead engaging means further includes a curved hook adapted to engage the space between the wheel rim and the tire bead.

9. A tire bead lifting tool as claimed in claim 8 wherein said rounded tip is adjacent said curved hook.

10. A tire bead lifting tool as claimed in claim 2 wherein said grip enhancement means comprises at least one raised cylindrical band on said outside surface area, said at least one raised cylindrical band being knurled.
